(19) United States
(12) Patent Application Publication
(10) Pub. No.: US 2012/0050003 A1
(43) Pub. Date: Mar. 1, 2012

(54) PROCESSING SYSTEM AND APPARATUS AND METHOD FOR PROTECTING A PROCESSING SYSTEM

(75) Inventor: PETER BERDELLE-HILGE, KONSTANZ (DE)

(73) Assignee: SIEMENS AKTIENGESELLSCHAFT, MUENCHEN (DE)

(21) Appl. No.: 12/869,862

(22) Filed: Aug. 27, 2010

(51) Int. Cl. G08B 29/00

(52) U.S. Cl. 340/5.2

(57) ABSTRACT

An apparatus and method for protecting a processing system, in particular a sorting system for postal items having at least two working planes above one another, is operable in a protection state and an access state. When the protection apparatus is in the protection state, a covering prevents access to the working planes from an access side. A closure of a passage opening in the covering is locked. After receiving an access signal, the protection apparatus changes to the access state. A drive then moves the covering so that the passage opening, following the movement, is in front of the working plane specified by the access signal. The closure is unlocked. A contact sensor monitors the closure and signals when the closure is closed. Closing the closure triggers a protection signal. The protection apparatus then changes to the protection state. The closure is locked. A processing system is also provided.

### BACKGROUND OF THE INVENTION

### Field of the Invention

The invention relates to a processing system, in particular a sorting system for postal items. The invention also relates to an apparatus and a method for protecting a processing system.

European Patent EP 1 608 470 B1, corresponding to U.S. Pat. No. 7,080,739, describes a system for sorting postal items. That system has two rows of sorting compartments above one another and accordingly two planes with processing devices.

European Patent EP 859 670 B1, corresponding to U.S. Pat. No. 6,068,109, also describes a system for sorting postal items having two rows of sorting compartments above one another.

The desire is to protect such a system in such a manner that both danger to careless operating personnel and damage to the system caused by external influence are prevented. The German DIN EN 292 standard “Safety of Machinery—Part 1” from 1991 requires, in section 3.13, safety functions, including isolating safety devices in section 3.22, for example a housing, a cover, etc.

An apparatus and a method of that type for protecting a system are known from U.S. Pat. No. 6,994,409. The apparatus described therein protects a storage device in the form of a cabinet having a large number of compartments. In one form, the apparatus includes four plates (“panels or screens”) which can be rolled up and two of which are respectively on a plane and butt against one another at an edge. If the two plates on a plane are pulled apart, a gap of variable width is produced. If that step is carried out for all four plates, a rectangular passage opening is produced. That opening is positioned in front of a compartment of the storage device. Each plate is locked.

A respective light barrier monitors the slot between two plates. At least one row of light barriers is interrupted when an item is in the opening. If the row of light barriers determines that an item is in the opening, a controller prevents the plates from being moved.

International Publication No. WO 99/43234 A1 describes a protection apparatus for a configuration which has a plurality of compartments beside one another. That protection apparatus has two plates between which a perpendicular slot is formed. A drive can move the plates in such a manner that both plates move at the same speed and the slot remains at the same width. A sensor is mounted on one of the two plates and reads a respective identifier from each compartment as it moves past the compartments. As soon as the slot is in front of a predefined compartment, the movement of the plates is stopped and a passage opening is formed precisely in front of that compartment.

### SUMMARY OF THE INVENTION

It is accordingly an object of the invention to provide a processing system and an apparatus and a method for protecting a processing system, which overcome the hereinafore-mentioned disadvantages of the heretofore-known systems, apparatuses and methods of this general type and which make it possible to quickly change over from an access state to a protection state after a fault has been eliminated.

With the foregoing and other objects in view there is provided, in accordance with the invention, a protection apparatus operable in a protection state and an access state for protecting a system having an access side, at least two working planes disposed above one another and devices each disposed in a respective one of the working planes for processing items. The protection apparatus comprises a covering having a passage opening formed therein. The covering prevents access to any of the working planes from the access side in the protection state. A lockable closure provided for the passage opening is locked in the protection state and unlocked in the access state. A contact sensor is configured to monitor whether the closure is open or closed and to trigger locking of the closure and changeover to the protection state upon determining that the closure is closed. A drive is provided for receiving an access signal specifying a working plane and for then changing over to the access state. The drive is configured to move the covering, after receiving the access signal, to position the passage opening in front of the specified working plane, as seen from the access side, and to permit access to the specified working plane while the covering simultaneously prevents access to any other working plane.

With the objects of the invention in view, there is also provided a processing system for sorting items. The processing system comprises at least two working planes disposed above one another, devices each disposed at a respective one of the working planes for processing items, and a protection apparatus according to the invention being configured to receive an access signal specifying a working plane and to then cause the specified working plane to interrupt processing of items until the protection apparatus has been changed to the protection state again, with every other working plane continuing to process items.

With the objects of the invention in view, there is concomitantly provided a method for protecting a system having an access side, at least two working planes disposed above one another and devices each disposed in a respective one of the working planes for processing items. The method comprises providing a protection apparatus operable in a protection state and an access state and having a covering with a passage opening disposed therein. A closure is provided for the passage opening. An access signal specifying a working plane is transmitted to the protection apparatus and subsequently: the protection apparatus is changed over to the access state, the covering is moved to position the passage opening in front of the specified working plane, as seen from the access side, and to enable access, with the covering simultaneously preventing access to any other working plane, the closure is unlocked and monitoring is automatically performed to determine whether the closure is open or closed. Upon determining that the closure is closed: the protection apparatus is changed over to the protection state again and the closure is locked.

The protection apparatus according to the invention is configured to protect a system having at least two working planes above one another, from an access side. Each working plane has a respective device for processing items.

The protection apparatus includes the following parts:

a covering,

a passage opening which is made in the covering,

a lockable closure for the passage opening,

a contact sensor for the closure, and

a drive for the covering.

The protection apparatus can be operated in a protection state and an access state. As long as the protection apparatus is in the protection state, the covering prevents access to any of the working planes from the access side. The closure is locked.

A signal generator outside the protection apparatus generates an access signal, for example a signal for a fault. This access signal specifies a working plane. After the access signal has been received, the protection apparatus changes over to the access state. After changing over to the access state, the protection apparatus carries out the following steps:

the drive moves the covering in such a manner that, following the movement, the passage opening is in front of the working plane specified in the access signal, as seen from the access side; and

the closure is unlocked.

The passage opening then makes it possible to access that working plane which is specified in the access signal. At the same time, the covering prevents access to any other working plane. This refinement ensures that it is possible to access only the specified working plane, for example the working plane with a fault. The covering also prevents operating personnel from being injured as a result of careless access to another working plane and prevents another working plane from being damaged from the access side.

The closure locks the passage opening and prevents anyone from opening the closure and accessing a working plane through the passage opening in the protection state. In the access state, the closure is unlocked, with the result that access is possible through the passage opening.

After the operating personnel have completed the work on the specified working plane, the personnel close the closure again. The contact sensor monitors the closure and signals as soon as the closure has been closed. The closing of the closure triggers the generation of a protection signal. The generation of the protection signal triggers the following steps:

the protection apparatus changes to the protection state; and

the closure is locked.

In the access state, the passage opening makes it possible to access the specified working plane, to be precise only as long as necessary. Every remaining working plane remains in operation, even while eliminating a fault on the specified working plane. The covering continues to protect and secure every remaining working plane. In the protection state, the protection apparatus protects every working plane.

The contact sensor causes a changeover from the access state to the protection state as quickly as possible. There is no need to generate a separate enable signal in order to confirm that the maintenance work has been completed.

The covering preferably includes two shutters. Each shutter can be rolled up and unrolled around an axis of rotation. The two axes of rotation run parallel to one another. In the access state, the passage opening is formed by a gap being produced between the two shutters. This gap forms the passage opening. In the protection state, the two shutters butt against one another at an edge and are locked against being rolled up and unrolled. This prevents a passage opening in the form of a gap being produced between the two shutters. The two lockable shutters simultaneously form the closure for the passage opening—in this case the slot between the two shutters.

After the access signal has been received, the drive positions the two shutters in such a manner that the edge between the shutters is in front of the specified working plane. At least one shutter is unlocked, with the result that it can be rolled up and unrolled, as a consequence of which the passage opening can be produced in the form of the slot.

This refinement saves space in comparison with an apparatus in which a rigid component is displaced. This refinement also eliminates the need for a window with a separate closure. In addition, this refinement makes it possible to provide a passage opening having a variable size, with the result that the protection apparatus can also be used for working planes of different heights without any additional outlay for equipment.

Other features which are considered as characteristic for the invention are set forth in the appended claims.

Although the invention is illustrated and described herein as embodied in a processing system and an apparatus and a method for protecting a processing system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side-elevational view of a sorting system with a protection apparatus in a protection state, as seen from an access side;

FIG. 2 is a side-elevational view of the sorting system with the protection apparatus in the protection state, as seen from the side and perpendicular to the access side;

FIG. 3 is a side-elevational view of the sorting system with the protection apparatus in an access state, as seen from the access side; and

FIG. 4 is a side-elevational view of the sorting system with the protection apparatus in the access state, as seen from the side and perpendicular to the access side.

### DETAILED DESCRIPTION OF THE INVENTION

Referring now to the figures of the drawings as a whole, there is seen an exemplary embodiment in which a protection apparatus is used in a sorting system for flat postal items (standard and large letters, postcards, catalogs, etc.). Each postal item extends on an item plane. This sorting system processes the postal items on three working planes above one another. Each working plane contains a respective conveying system for transporting upright postal items. Each postal item is transported on at least one respective working plane, with the result that each conveying system transports a sequence of successive postal items.

Each conveying system preferably includes a system of endless conveyor belts. Two respective conveyor belts, which are opposite one another, clamp an upright postal item between them and rotate at the same speed, as a result of which the postal item is transported. At least one working plane contains a discharging device. Depending on a destination address read from the postal item and a sorting plan, this discharging device discharges each postal item into a respective output compartment of the sorting system.

Faults may occur when transporting the postal item. For example, a plurality of overlapping postal items or an individual postal item which is too thick or too rigid may cause a jam, or a mechanical fault may occur in a conveying system. A sensor measures such a fault. A central controller of the sorting system is supplied with messages from these fault sensors and automatically detects the working plane on which the fault has occurred. The controller switches off the conveying system of this working plane. The conveying systems of the remaining working planes remain in operation and continue their work. Through the use of the invention, only one working plane thus needs to be temporarily deactivated if a fault occurs on this working plane. The remaining working planes continue to process postal items.

Operating personnel can access the working planes from an access side. A covering with a passage opening, which can be positioned, is located between the operating personnel and the three working planes.

The sorting system is operated either in a fault-free mode or in a fault mode. If a fault sensor signals a fault, the central controller changes over the sorting system to the fault mode. The protection apparatus having the covering, as described below, operates either in a protection state or in an access state. As long as the sorting system is operated in the fault-free mode, the protection apparatus is in the protection state. The operation in which the central controller changes over the sorting system to the fault mode results in the protection apparatus being changed over to the access state.

If the sorting system is in the fault-free mode and the protection apparatus is thus in the protection state, the passage opening is closed and the covering prevents any of the working planes from being accessed from the access side. As a result, the covering protects the operating personnel from injury and protects the working planes from access and other external influences.

If a fault occurs on a working plane, the central controller transmits an access signal to a local controller of the protection apparatus. This access signal specifies that working plane which has been identified by the central controller as the location of the fault on the basis of the sensor messages. The local controller controls a drive of the protection apparatus in such a manner that the drive positions the passage opening in front of the working plane specified in the access signal. The passage opening is unlocked.

As a result, the operating personnel gain access to the working plane having the fault. However, the covering continues to prevent access to the other working planes which are still in operation. The operating personnel eliminate the fault on the working plane, for example by removing the jammed postal items or rectifying the mechanical fault. The operating personnel then close the passage opening. A contact sensor automatically detects that the passage opening has been closed again. The contact sensor then generates an enable signal which is transmitted to the local controller and, from the latter, to the central controller. After receiving the enable signal, the central controller changes over the sorting system to the fault-free mode again and reactivates the working plane which was switched off due to the fault. The local controller changes over the protection apparatus to the protection state again.

In one embodiment, the covering is in the form of a system having two shutters. The latter are fitted above one another, as seen in the direction of gravity. The lower shutter can be rolled up around a horizontal first axis which extends at the level of or below the lowermost working plane. The upper shutter can be rolled up around a horizontal second axis which extends at the level of or above the uppermost working plane. The two shutter axes run parallel to one another. The shutters are subdivided into lamellae which can be rotated with respect to one another.

Guide rails, in which guide pins of the shutters run up and down, are fitted beside the shutters. As a result, the shutters always remain on a plane which is preferably perpendicular to the access plane.

If the sorting system operates in the fault-free mode and the protection apparatus thus operates in the protection state, the two shutters butt against one another at a horizontal edge, with the result that the covering is closed. Locking of the two shutters prevents one of the shutters from being able to be rolled up or unrolled and thus prevents a gap from being able to be produced between the two shutters. The two shutters together protect all working planes from access from the access side. The drive is subdivided into two individual drives, one for each shutter. The local controller is connected to the two drives. Each individual drive is configured to roll up and unroll a shutter around an axis of rotation.

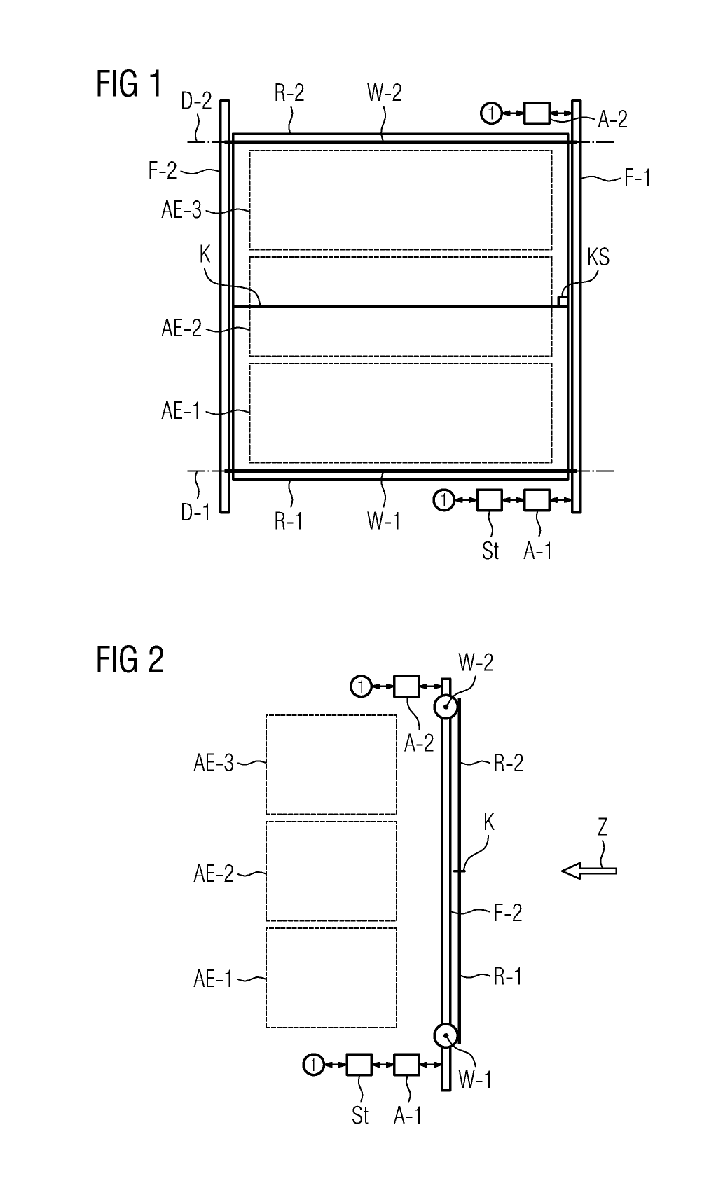

Referring now to the figures of the drawings in detail and first, particularly, to FIG. 1 thereof, there is seen a sorting system with a protection apparatus in a protection state, as seen from an access side Z. FIG. 2 shows the sorting system with the protection apparatus of FIG. 1 in the protection state, as seen from the side and perpendicular to the access side Z.

Two shutters or coverings R-1 and R-2 butt against one another at an edge K in the protection state. The shutters are held in two guide devices F-1 and F-2, between which working planes AE-1, AE-2 and AE-3 are defined. As seen from the access side Z, the guide device F-1 is fitted to the left of the shutters and the guide device F-2 is fitted to the right of the latter.

A drive A-1 is configured to unroll and roll up the lower shutter R-1 around an axis of rotation D-1. A drive A-2 is configured to unroll and roll up the upper shutter R-2 about an axis of rotation D-2. The two axes of rotation D-1 and D-2 run parallel to one another. For example, the drive A-1 rotates a shaft W-1 which runs along the axis of rotation D-1, and the shutter R-1 is rolled up around the shaft W-1 or is unrolled from the latter. In a corresponding manner, the drive A-2 rotates a shaft W-2 which runs along the axis of rotation D-2, and the shutter R-2 is rolled up around the shaft W-2 or is unrolled from the latter.

Both drives A-1 and A-2 are connected to a local controller St. The local controller St transmits actuating signals to these drives. A contact sensor KS monitors whether or not the two shutters R-1 and R-2 butt against one another at the edge K. The contact sensor KS transmits its measurement results to the local controller St.

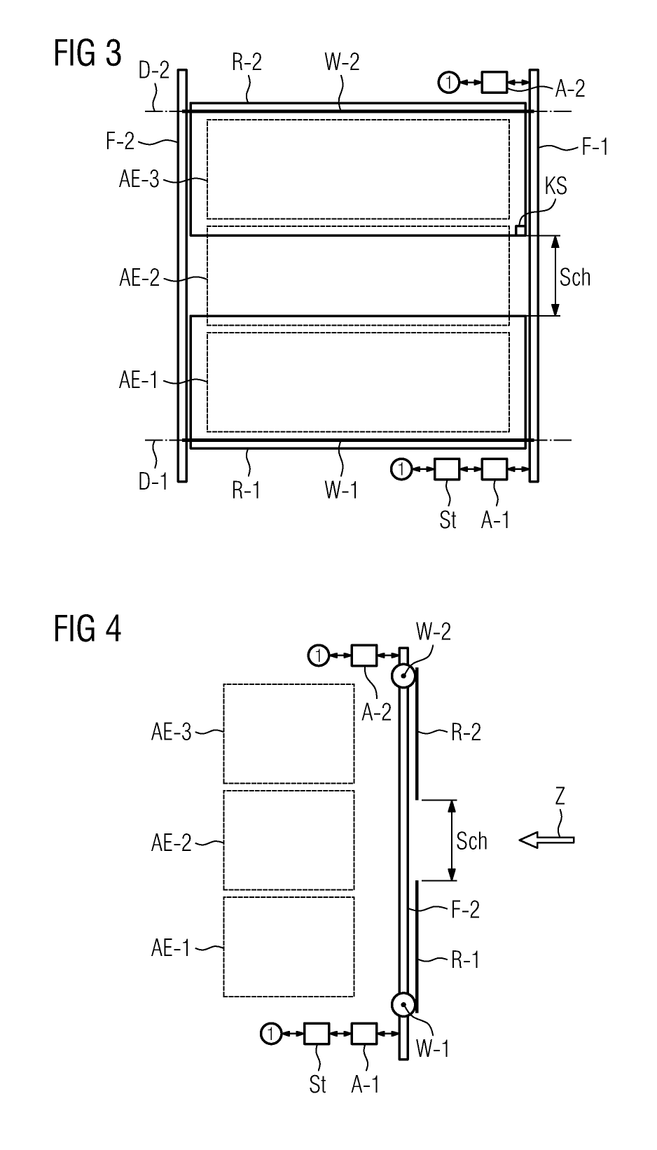

FIG. 3 shows the sorting system with the protection apparatus in the access state, as seen from the access side Z. FIG. 4 shows the sorting system of FIG. 3 with the protection apparatus in the access state, as seen from the side and perpendicular to the access side Z. In the example shown in FIG. 3 and FIG. 4, the access signal contains a message that a fault has occurred on a working plane AE-2.

As soon as the central controller changes over the sorting system to the fault mode and changes over the protection apparatus to the access state, the following steps are carried out:

The drives A-1, A-2 position the two shutters R-1, R-2 in such a manner that, after positioning, the horizontal edge K between the two shutters R-1, R-2 is at the level of the working plane AE-2 having the fault;

The drives A-1, A-2 then roll up at least one shutter by a predefined amount, that is to say a drive either rolls up the upper shutter R-1 or rolls down the lower shutter R-2. It is also possible for the operating personnel to manually roll up or unroll this shutter. As a result, a passage opening in the form of a slot Sch is formed between the two shutters R-1, R-2 and in front of the working plane AE-2 having the fault;

After the shutters have been separated from one another to such an extent that the slot Sch is formed, the shutters preferably butt against a stop and are locked. On one hand, this locking of the shutters R-1, R-2 in the access state in combination with the stops prevents the shutters R-1, R-2 from being rolled up too far and thus enabling access to another working plane AE-1, AE-3. On the other hand, the locking prevents the shutters R-1, R-2 from closing on their own while the operating personnel are accessing the working plane AE-2 with the fault and are eliminating the fault;

The operating personnel access the working plane AE-2 with the fault through this slot Sch and eliminate the fault;

After the operating personnel have eliminated the fault, the operating personnel close the passage opening by moving at least one shutter to such an extent that the slot Sch is closed. For example, the operating personnel may move both shutters R-1, R-2 toward one another until they butt against one another. It is also possible for the operating personnel to actuate an actuating element and for the drives A-1, A-2 to then automatically close the slot Sch again;

The contact sensor KS measures whether or not the shutters R-1, R-2 touch at the horizontal edge K and generates the enable signal as soon as it has determined that the shutters touch and butt against one another at the edge K. “Touch” can also mean that the distance between the shutters R-1, R-2 is smaller than a predefined limit;

This monitoring is carried out in order to rule out the possibility of the shutters R-1, R-2 tilting or an item being disposed between the shutters and the slot Sch therefore not being able to be closed.

In a second embodiment, the passage opening is made in a cover in the form of a window. The window has fixed dimensions. The contact sensor again measures whether or not the closure for the window is closed.

In a third embodiment, the covering is in the form of a one-piece shutter which can be moved up and down in a frame. If the shutter is moved upward, a passage opening is produced between the shutter and the frame. The shutter can be locked in the frame. The contact sensor measures whether or not the shutter is in the lowermost position, where the passage opening is completely closed.

If the sorting system is operated in the fault-free mode and the protection apparatus is therefore operated in the protection state, the window is closed and locked. If a fault occurs on a working plane, the drive positions the window in front of the working plane. For this purpose, the drive rolls the shutter with the window up or down. The drive unlocks the window. The operating personnel open the window and rectify the fault. The operating personnel then close the window again, whereupon the contact sensor generates the enable signal.

As long as the contact sensor has not generated the enable signal, the protection apparatus remains in the access state. The working plane which can be accessed remains deactivated and cannot injure a worker. The protection apparatus is changed over to the protection state only when the contact sensor has generated the enable signal, and the working plane which previously had the fault continues the sorting operation. This gives rise to “fail-safe” operation: if the contact sensor fails and cannot generate an enable signal, the apparatus remains in the access state and the working plane remains in the deactivated state. It is neither necessary nor possible to use a separate enable signal to cause the working plane, which previously had the fault, to continue its work. This prevents the working plane from sorting even though the passage opening is not closed or the closure is not locked.

The refinement with one or more shutters R-1, R-2 saves space in comparison with a refinement having a rigid component which is displaced. When rolled up, a shutter takes up little space.

In one development, each working plane is subdivided into a plurality of respective regions which are disposed beside one another. The fault sensor signals which region of which working plane has the fault.

In the embodiment with the slot Sch between the shutters R-1, R-2, which is shown in the figures, each shutter is subdivided into at least two shutter parts which are beside one another. Each shutter part can be rolled up and unrolled independently of the other shutter parts. Guide rails are fitted between two adjacent shutter parts. In the fault-free mode, two shutter parts which are disposed above one another respectively butt against one another at a horizontal edge. If a fault is signaled in a region, the drive positions the two shutter parts, which are in front of this region, in such a manner that the edge is in front of the region with the fault, and moves at least one shutter part in such a manner that a slot is produced in front of the region.

In another embodiment with the window in the shutter, the covering includes a plurality of shutter parts each with a window. The shutter parts with the windows are disposed beside one another. Each shutter part can be rolled up and unrolled independently of the other shutter parts. When a fault is signaled in a region, the drive rolls up or unrolls the shutter part in front of this region, with the result that the window is positioned in front of the region. The window is then unlocked.

This embodiment results in shutters which are smaller and therefore lighter than the embodiment with the continuous shutters. As a result, the drive needs to perform less work in order to position the passage opening and accomplishes positioning in a faster manner.

The entire covering is preferably produced from transparent material. As a result, the operating personnel always have visual contact with the working planes and can visually monitor the work of the conveying systems.

1. A protection apparatus operable in a protection state and an access state for protecting a system having an access side, at least two working planes disposed above one another and devices each disposed in a respective one of the working planes for processing items, the protection apparatus comprising:
a covering having a passage opening formed therein, said covering preventing access to any of the working planes from the access side in the protection state;
a lockable closure for said passage opening being locked in the protection state and unlocked in the access state;
a contact sensor configured to monitor whether said closure is open or closed and to trigger locking of said closure and changeover to the protection state upon determining that said closure is closed; and
a drive for receiving an access signal specifying a working plane and for then changing over to the access state, said drive configured to move said covering, after receiving the access signal, to position said passage opening in front of the specified working plane, as seen from the access side, and to permit access to the specified working plane while said covering simultaneously prevents access to any other working plane.

2. The apparatus according to claim 1, wherein the protection apparatus is configured to remain in the access state, after changing over to the access state, at least until said contact sensor has determined that said closure is closed.

3. The apparatus according to claim 1, wherein:
said covering includes a shutter to be rolled up or unrolled about an axis and locked against being rolled up and unrolled when the protection apparatus is in the protection state; and
said drive is configured to position said shutter, after receiving the access signal, with said passage opening in front of the specified working plane, as seen from the access side.

4. The apparatus according to claim 1, wherein:
said covering includes two shutters to be rolled up and unrolled about two respective mutually parallel axes, said shutters, when the protection apparatus is in the protection state, being locked against being rolled up and unrolled and being butted against one another at an edge, thus forming said closure for said passage opening;
said drive being configured to position said shutters, after receiving the access signal, with said edge in front of the specified working plane, as seen from the access side; and
at least one of said shutters being configured to be rolled up or unrolled in the access state so that, after said two shutters have been positioned and at least one of said shutters has been rolled up or unrolled, said passage opening is formed between said two shutters in the form of a slot.

5. The apparatus according to claim 4, wherein said contact sensor is configured to measure whether or not said two shutters butt against one another at said edge and to generate a protection signal as a result of measuring an abuttment of said two shutters.

6. A processing system for sorting items, the processing system comprising:
at least two working planes disposed above one another;
devices each disposed at a respective one of said working planes for processing items; and
a protection apparatus according to claim 1 being configured to receive an access signal specifying a working plane and to then cause the specified working plane to interrupt processing of items until the protection apparatus has been changed to the protection state again, with every other working plane continuing to process items.

7. The processing system according to claim 6, wherein said devices for processing items on each of said at least two working planes disposed above one another, are devices for sorting items.

8. A method for protecting a system having an access side, at least two working planes disposed above one another and devices each disposed in a respective one of the working planes for processing items, the method comprising the following steps:
providing a protection apparatus operable in a protection state and an access state and having a covering with a passage opening disposed therein;
providing a closure for the passage opening;
transmitting an access signal specifying a working plane to the protection apparatus and subsequently:
changing over the protection apparatus to the access state;
moving the covering to position the passage opening in front of the specified working plane, as seen from the access side, and to enable access, with the covering simultaneously preventing access to any other working plane;
unlocking the closure; and
automatically monitoring to determine whether the closure is open or closed; and
upon determining that the closure is closed:
changing over the protection apparatus to the protection state again; and
locking the closure.

9. The method according to claim 8, which further comprises keeping the protection apparatus in the access state, after changing over to the access state, at least until a contact sensor has carried out the step of determining that the closure is closed.

10. The method according to claim 8, which further comprises:
providing the covering with two shutters to be rolled up and unrolled about two respective mutually parallel axes;
triggering the following steps upon receiving the access signal:
positioning the two shutters to butt against one another at an edge in front of the specified working plane, as seen from the access side, and
unlocking and rolling up or unrolling at least one of the shutters, to form the passage opening in the form of a slot between the two shutters;
carrying out the monitoring step by monitoring whether the slot is still present or whether the two shutters butt against one another again at the edge; and
upon determining that the shutters butt against one another:
changing over the protection apparatus to the protection state, and
locking both shutters against being rolled up and unrolled.
